(19) United States
(12) Patent Application Publication
(10) Pub. No.: US 2023/0351423 A1
(43) Pub. Date: Nov. 2, 2023

(54) DYNAMIC SELECTION OF GROUPS OF USERS IN A COMPUTERIZED SYSTEM

(71) Applicant: FOREQUEST ITALIA S.R.L, Milano (IT)

(72) Inventor: Aurelio Augusto Filippo Tarantino Gotti Lega, Capannoli (IT)

(21) Appl. No.: 18/038,058

(22) PCT Filed: Nov. 23, 2021
(86) PCT No.: PCT/IB2021/060850

§ 371 Date: May 22, 2023

(30) Foreign Application Priority Data
Nov. 24, 2020 (IT) 102020000028166

(51) Int. Cl. G06Q 30/0204; G06Q 30/0251

(52) U.S. Cl. CPC G06Q 30/0204; G06Q 30/0251

(57) ABSTRACT

A computerized method for dynamic selection of groups of users to whom messages are to be sent, said method comprising in a computerized system a first definition phase in turn comprising the steps of forming a general database of users with information characterizing each user, entering in a user type database information characterizing an initial user type, entering in a message database one or more messages associated with the user type. During a second operating phase the computerized system automatically: selects a group of real users from the general database of users based on the characteristics defined for the user type; sends to a personal device of the users of the group of real users selected the messages of the message database associated with the user type; receives from the personal device of the users an answer entered by the user in response to the message received; obtains from the answers received from the users a modification of the information characterizing the user type in the user type database; and cyclically repeats the second operating phase for a dynamic selection of the user group to whom the messages of the message database associated with the user type are to be sent.

The present invention relates to a method and a computerized structure for the dynamic selection of groups of users responding to messages sent from a remote system.

In the art it is known that there exists the possibility of sending messages to groups of users previously selected on the basis of these users' characteristics which are stored in a database. For example, in the case of messages providing information about particular products offered on the market, it is possible to select from a database of generic users certain users who have been identified beforehand as being potentially interested in these products, so as to send the relevant messages only to them.

The known systems have, however, for example the drawback that, in the event that the initial group has not been accurately defined, sending of the messages may not achieve the goal of optimizing the contact with the users concerned. For example, the selected group may be chosen based on an excessively narrow criterion and therefore contains fewer users than those who would in reality be interested or, on the other hand, the selected group may be chosen using a criterion which is too broad and therefore contains many users who in reality are not interested in this type of message, therefore resulting in the unnecessary sending of messages. In either case, in addition to a non-optimum result in terms of the contacts reached by the messages, there is also a non-optimum use of the network resources with a non-optimum number of messages being generated and sent on the network.

When the groups of users are of the order of millions, or tens of millions, if not hundreds of millions of users, the non-optimum use of the resources may become extremely disadvantageous, especially if there is a relatively high number of messages which are to be sent to each user.

The general object of the present invention is to provide a method and a computerized system applying this method in order to select dynamically and automatically groups of users who are connected to the system and to whom messages are sent, so as to optimize the number of users receiving these messages.

In view of this object the idea which has occurred, according to the invention, is to provide a computerized method for dynamic selection of users to whom messages are to be sent, comprising in a computerized system a first definition phase in turn comprising the steps of:
forming a general database of users with information characterizing each user,
entering information characterizing an initial user type in a user type database;
entering one or more messages associated with the user type in a message database;
   and a second operating phase in which the computerized system automatically:
selects a group of real users from the general database of users based on the characteristics defined for the user type;
sends to a personal device of the users of the selected real user group the messages of the message database associated with the user type;
receives from the personal device of the users an answer entered by the user in response to the message received;
extracts from the answers received from the users a modification of the information characterizing the user type in the user type database; and
cyclically repeats the second operating phase for dynamic selection of the user group to whom the messages of the message database associated with the user type are to be sent.

Still in accordance with the invention the idea which has occurred is to provide a computerized system which applies the method of the invention and which comprises the database of information characterizing a user type, the message database, the general database of users, a terminal suitable for entering messages in the message database and information characterizing at least one user type in the database of information characterizing a user type, a comparator module for comparison of the information contained in the general database of users and in the database of information characterizing a user type, and the selection of groups of real users from the general database of users depending on the result of the comparison, a sending module suitable for sending messages contained in the message database to the personal devices of the groups of users selected by the comparator module, a module for receiving answers from the personal devices and suitable for modifying on the basis of the answers received the information present in the database of information characterizing a user type.

In order to illustrate more clearly the innovative principles of the present invention and its advantages compared to the prior art, an example of embodiment applying these principles will be described below with the aid of the attached drawings. In the drawings:

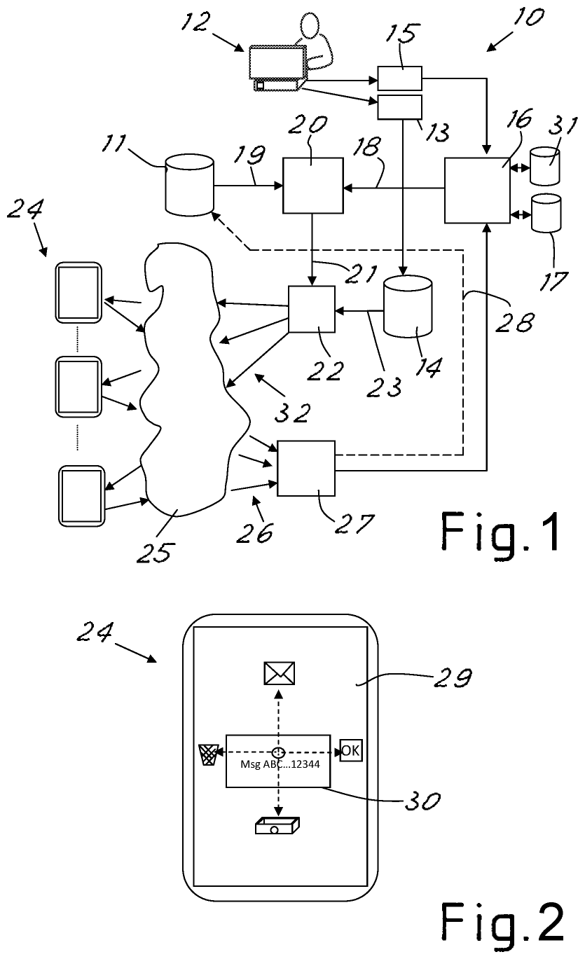

FIG. 1 shows a block diagram of a computerized system for the dynamic selection and sending of messages, provided in accordance with the present invention;

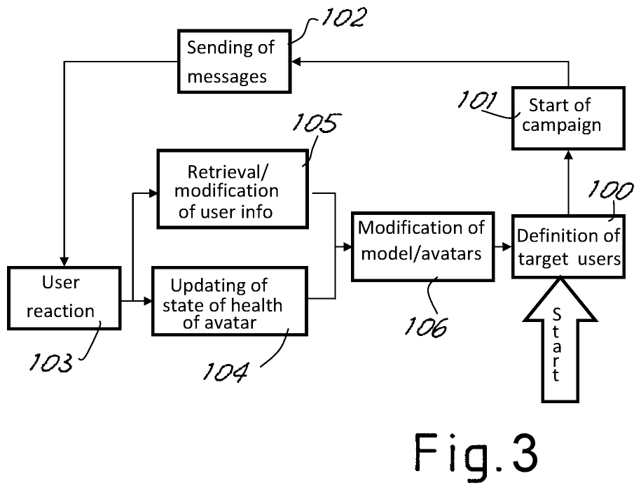

FIG. 2 shows in schematic form a user device for connection to the system and for allowing a user to interact with said system so as to allow easy dynamic selection of the user groups;

FIG. 3 shows a possible functional diagram of the system according to the invention;

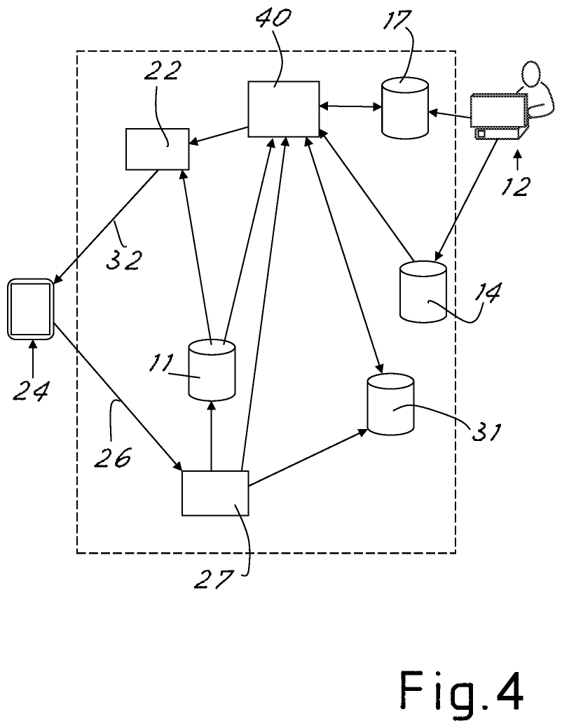

FIG. 4 shows a basic block diagram of a possible information flow for operation of the system according to the invention.

With reference to the figures, FIG. 1 shows in schematic form a computerized system provided according to the invention and denoted generally by 10.

This computerized system comprises a general database of users 11, which contains the data of users from whom the user groups are to be dynamically selected. The users will each have, associated with them in the database, a contact address to whom the messages are sent and one or more characteristics which define the user and which have been considered useful for defining the user for the purposes of subsequent selection. The characteristics will be defined on the basis of the selections which are to be made. For example, these characteristics may comprise the age, sex, personal interest, geographical location zone, etc.

A system operator may enter, via a terminal 12, a number of messages, as required, which are to be sent to groups of users selected from the users stored in the database 11. These messages, which may be processed by a first processing stage 13 so as to be in a format suitable for sending using specific selected methods, are stored in a message database 14.

Again via the terminal 12 the system operator may also enter manually a first selection of characteristics of users to whom the messages are to be sent. For example, the operator may consider that the users interested in the messages are those who fall within an age range of 30 to 40 years and will therefore enter this characteristic as a parameter for selection of the users. The characteristics entered by the operator, which may be processed by a user processing stage or modules in order to be formalized, are sent to a stage 16 or modules for creation and management of one or more virtual user types, the characteristics of which are stored in a user type characteristics database 17.

For example, if the characteristics entered by the operator are those of users who are between 30 and 40 years old and live in a certain geographical area, the user type creation stage will store these characteristics in the database 17 so as to define one or more user types 18 with these characteristics.

Each user type thus created may be referred to here as an “avatar”, i.e. a virtual user who, as will be clarified below, will evolve so as to become increasingly more “suited” for the messages sent and with whom the characteristics of the real users in the general database 11 will be compared, so as to select those user groups most similar to the avatar (or avatars since more than one may be simultaneously created).

Once the first definition phase has ended, an automatic operating phase starts where the user types or avatars 18, identified by their characteristics, are compared with the real users 19 of the general user database 11 by means of a comparator stage or module 20 so as to extract from the general user database 11 only those real users 21 who resemble the user type 18, with a possible more or less predefined difference.

In particular, the characteristics which define the avatars will be compared with the corresponding characteristics of the real users defined in the general database 11 so as to select those real users who “resemble” the avatar (less, if necessary, a predefined “delta”).

The contact addresses of the real users 21 thus selected are passed to a sending module 22 which retrieves the associated messages 23 from the message database 14 and sends them as selected messages 32 to personal devices or terminals 24 which are associated with the selected users and which can be reached via the contact addresses of the users. For example the terminals 24 may be mobile terminals of the users, such as smartphones, and the contact addresses may be known electronic addresses which define the terminal in the network 25 via which the messages may be conveyed to the terminals 24. In any case, advantageously the terminals 24 and the computerized system are designed to exchange information via a wireless communication network and, in particular, a cellular communication network.

Each terminal 24 allows the user to respond to the message received by means of an answer 26 which is chosen from a certain number of predefined answers and which will be sent back to the system for dynamic selection of the users.

The answers will be received by an answer processing module 27 which, based on them, will modify the characteristics of the user type used for selection. In this way, the comparator stage 20 will select a new group of real users 19 which may also be potentially different from the previous group and the messages will thus be sent to the new group. For modification of the characteristics of the user type the characteristics of the user type will for example be made more similar to those of a user who responds positively to the message. This may also be realized taking into account the percentage of positive answers compared to the total number of users who respond. The user type will for example have characteristics which are an average, or which comprise on average, the characteristics of the users who have replied positively.

The cycle of sending, receiving the replies, adapting the characteristics of the user type, selecting a corresponding group of users to whom new messages can be sent, and so on, will be cyclically repeated in order to select dynamically the users with greater precision and therefore gradually send the messages in a more optimized manner.

If necessary, depending on the responses 26 received, it is also possible to insert in the general database 11 of the users also new users 28 who were not originally present, as will be explained below.

The method of choosing the answer by a user may vary depending on the type of terminal used.

FIG. 2 shows a possible example of a mobile terminal 24 with possible predefined answers to the messages received and with a touch screen display 29 on which a window 30 with a message sent to the mobile terminal from the system 10 is shown. The mobile terminal may be for example a smartphone or other device known per se, suitably programmed and connected to the network 25.

Once the message has been shown on the display 29, the system considers the possible answers from the user. With a terminal of the type shown in FIG. 2, the answer is advantageously produced by the user by means of interaction with the touch screen display so as to move virtually the message on the display (swipe) depending on the answer which is to be given.

In the simplest form of interaction, the messages may be answered in two ways, i.e. acceptance of the message because it is of interest, or refusal of the message because it is not of interest (for example with movement to the right for acceptance and movement to the left for refusal).

The acceptance may also result in further screens (not shown) which explain the message in more detail. For example, initially the message shown may be a simple general description of a product which is offered for sale. If the user accepts the message, further information about the product may be subsequently displayed. The user may also be connected to a site of the product vendor so as to continue to receive information and if necessary acquire the product.

Preferably, in a more sophisticated form of the system, the possible answers offered for selection may be more than two. For example, it has been found to be particularly advantageous for there to be at least four possible responses.

For example, the possible responses may be acceptance, refusal, forwarding of the message to another recipient chosen by the user from among his/her contacts or archiving of the message for future consideration by the user.

Advantageously, in the case of a touch display the four possible responses may be associated with four different directions (top, bottom, right, left) towards which the message on the screen may be virtually moved. For example, as shown in FIG. 2, the movement towards the right will result in acceptance of the message by the user and the movement towards the right will result in refusal of the message because it is of no interest for the user, while the movement upwards will result in sending of the message to another recipient (chosen by the user from among his/her contacts, for example by means of a subsequent selection screen, not shown in that it is per se of the known type which may be easily imagined by the person skilled in the art) and the downwards movement may result in archiving of the message because it is of interest, but will be looked at later.

Obviously, the answers may be provided by the user in a different manner (which may now be easily imagined by the person skilled in the art based on the description provided here), for example via a keyboard or the selection of icons on the screen, even if the method described has been found to be particularly advantageous in order to obtain an immediate and simple response from the user.

In any case, the user's answers are sent via the network 25 to the module for processing the answers 27, together with the answers of all the other users who have received the message.

By means of processing of the answers it is thus possible to obtain the percentage of users with the initially selected characteristics who responded positively or negatively to the message and modify automatically the characteristics 17 of the user type based on these answers. For example, if the user type had as an age characteristic an age ranging between 40 and 50 years, but the reals users who were aged between 40 and 45 answered mainly negatively to the message received, the age characteristics of the user type may be automatically modified by the system to 46-50 year olds and the selection module 20 will select the real users in the database 11 having this age range for the sending of a new message. Obviously any other characteristic which defines the user type may be similarly used, modified and automatically selected.

In this way there will be a continuous refinement of the groups of real users to whom the message will be sent.

For example, with messages defined as a consecutive chain of correlated messages, the subsequent messages in the chain will be sent to more specific groups of users as the dynamic selection described here proceeds.

In the case where the system envisages an answer from a user which involves sending the message to another user not included in the selection, the characteristics of this other user may also be used to refine the characteristics of the user type, such as to comprise also this other user in the selected group (at least until this other user does not reply in turn to the message, possible refusing the message or forwarding it in turn). If another user is not contained in the general database 11 of the users said user may be obviously added automatically to the database 11 for future selections, the new user being asked for his/her defining characteristics to be used for future selections (if not already recorded in the system).

Preferably, the general database 11 may be formed by all those users who have subscribed to the message sending service of the system 10, for example by installing in their device 24 a special program (for example an App for a smartphone) which allows the message to be received and multiple answers to be sent as made possible by the system. In this case, the program during installation on the device 24 may request all the user data useful for associating with this user the characteristics which will then be used for dynamic selection thereof as described above.

Obviously, the user types created by the module 16 may also be at the same time more than one, distinguished by different characteristics, such that it is also possible to select simultaneously several groups of real users to whom the same message (or set of messages) may be sent.

The more or less positive response of the real users selected based on a user type, defined as an avatar, may also be used to define a “state of health” of the avatar. In particular, the more the answers are positive (i.e. essentially a non-refusal of the message), the more the associated avatar will enjoy good “health” and be used for selection of the groups. On the other hand, the more the answers are negative, the more the avatar will be less “healthy” and will be used less for selection of the groups. Essentially, the “health” of the avatars may be compared to a percentage of approval (or positive answers) of the real users selected and will be used to establish the next dynamic selection of the user groups. The state of heath may be represented for example by a value which increases by one unit (or a predetermined percentage) for each positive answer of a user selected depending on the associated avatar and which decreases by one unit (or a predetermined percentage) for each negative answer of a user selected on the basis of the associated avatar.

If the messages in the database 14 relates to products (for example messages for the sale of particular products or categories of products), the system may also comprise a further database, indicated by 31 in FIG. 1, which contains possible correlations between different products or different categories of products.

This database 31 may contain information (in the form of correlation or “product model” rules) characterizing various types of products and their mutual affinity (for example beverages⇔food, dinner⇔entertainment, food types such as “vegetarian” “non vegetarian”, etc.) depending on any rule defined for example by the system operator.

The database 31 may be used by the module 16 in order to manage the variations of the model of the avatar. i.e. of the user types, offering the possibility of correlating the products of the message campaign with the preferences of other potential users defined in the general user database 11. In other words user types may be formed or modified by the module 16 by identifying correlations between the preferences of users stored in the general database and the products of the specific message campaign. In this way, other users who had expressed previously preferences for products/messages which are different, but considered to be related in the database 31, may be selected.

The basic configuration of the database 31 may be initially defined during the settings stage (for example by the operator who enters the messages via the terminal 12) and may be refined by means of the introduction of new rules/clusters of products automatically by means of analysis of the reactions of the users to different campaigns and products, extrapolating new product preferences (for example rules such as “the person who buys X often buys Y”) and product type segmentation (sports clothing, vegan food, etc.).

The correlations therefore may be inserted a priori and/or evolve following the start of different message sending campaigns and the responses of the users to these campaigns.

During the definition of an advertising campaign the products advertised may be characterized so as to be able to identify their location in the product model defined by the database 31 and consequently allow the avatar to address, depending on the reactions of the users, other target customers having preferences compatible with or similar to that which is directly included in the campaign.

The avatar thus learns by means of a machine learning system, for example, which is supplied with the continuous reaction of the users to the message campaigns (for example product advertising campaigns) targeting the selected users By means of the information acquired from the user reactions, the actual habits of the users (times, days, etc.) and the product correlation models, the avatar component will modify the associated cognitive model, identifying new users of interest, new periods of interest, new products of interest and consequently will increasingly focus its attention on the ideal users at the ideal time.

FIG. 4 shows a basic block diagram of a possible information flow in the system according to the invention and preferably also comprises the product models of the database 31.

According to this flow the operator inserts via the terminal 12 the information of the message (product) campaign to be realized, said information being stored in the database 14, and the information relating to the characteristics which it is considered the user types should have and which are stored in the database 17. In this way the initial configuration information is therefore entered. This information is supplied to the avatar “engine” 40 which may comprise for example the modules 16 and 20 (and optionally part of the module 22) shown in FIG. 1.

Basically the database 17 therefore contains the so-called avatars model and the database 14 therefore contains the so-called campaigns models.

With suitable selection by the avatar engine 40 the information relating to the messages to be sent and the users to whom they are to be sent therefore pass from the message database 14 and the general user database 11 to the sending module 22 which receives the sending rules and transmits the messages to the users, depending on the transmission information of the suitably selected user database 11. The message sending module 22 may also form or contain a so-called “Ads Moderator Engine”, namely a moderating filter which prevents a user from being bombarded with too many messages during brief periods and at the same time avoids competition between avatars regarding the end user. In this way, not only will the end user not receive repeated messages (e.g. for the same product, but a different brand, but the system may combine the messages which are compatible with each other (e.g. pizza and beer or coffee and sugar) so as to maximize the user's interest who will be encouraged to continue to use the App for interaction with the system on his/her device 24.

The answers processing module 27 will be able to provide information based on the users' answers so as to help management of the avatars' behaviour by the avatar engine 40, both by sending it the information regarding the reactions of the users and by modifying the selection of the users from the database 11 as well as the correlations of the correlations database 31. The same avatar engine 40 may modify the correlations between the products in the database 31 on the basis of the experience gained from user behaviour in the various campaigns.

The management of the avatar can be done with the aid of typical artificial intelligence and machine learning tools in the big data world (trained by user reactions on the mobile device) using what may be defined as “system cognitive models”. The continuous dynamic evolution of the models (i.e. avatars or user types) makes it possible, after a short time, to ensure that messages are sent to the ‘ideal’ user for that type or set of messages. For example, if the messages are associated with an advertising campaign, e.g. as promotional messages (possibly as a sequence of promotional messages), these messages will be sent to the “ideal” user for the proposed campaign.

This avoids, for example, unnecessary over-messaging, resulting in not only more effective messaging, but also less disruption of users not interested in the proposed campaign. This also avoids an advertising campaign generating annoyance in the mass of users because it is sent repeatedly to uninterested recipients, which in the long run could lead uninterested users to consider the product being campaigned or the company proposing it as ‘annoying’, which would certainly be detrimental for the company's image. Moreover, if messages are considered to be annoying or if too many of them are sent, they may in the long run be blocked or obstructed by automatic spam filters or other similar network protection systems.

Moreover, the use of the system according to the invention is able to reduce the load of the network and the message campaign management system, with significant savings in terms of technological resources and therefore a significant reduction in in the costs of sending and managing the messages. This also makes it technically feasible to carry out campaigns with a very large number of recipients without overloading the computerized structures of the network.

As a result of the invention it will also no longer be necessary to modify models and strategies after arduous time-consuming analyses of the data collected; instead the best, dynamically updated cluster of ideal users will always and constantly be available.

Owing to the solution described it is possible to define target customers as customer types, e.g. using all the statistical information contained in the general user database of the system, and then simply start the campaign with messages, e.g. about products to be promoted, initially sent to the group of target customers identified in the first definition phase. The dynamic avatar will then continuously select groups of real users, starting from the selection rules defined in the first phase, but updating these selection rules (i.e. the characteristics of the users to be selected) according to the responses of the users themselves, and thus applying the dynamic selection rules to the general user database of the system.

Possible characteristics used for the refinement of the avatar may also include the reaction times and times during the day and days when the users sending the responses react. This allows the avatar to also have an understanding of the degree of interest roused in the users by the various messages.

Messages may also be linked to the location of the user, detected by known techniques via the user's mobile device. In this case, when the user's position varies and the user approaches for example a position of interest (e.g. proximity to a shopping centre with special offers, a tourist resort, a museum, etc.), the avatar will receive notification of the variation and will proceed to send the message, in the case where the user is a user selected as recipient of the position-related message.

For an even better understanding of the present invention, a possible functional diagram of the method, implemented by the computerized system 10, is summarised in FIG. 3.

Basically, at the start of a message sending campaign (for example an advertising campaign), in a first step the target customers (step 100), i.e. the clusters of users targeted by the campaign, are defined, for example using all the information contained in the user database of the system.

Then (step 101) the campaign is started by means of the avatar that is initially set up for the set of users identified in the first step.

The sending of messages thus begins (step 102), with the avatar selecting the groups of real users satisfying the selection rules defined in the first step.

The “reactions” of the users are thus received (step 103), allowing updating of the avatar's “state of health” (step 104) and also modification if necessary of the information known for the users who reply (step 105).

On the basis of this, it is thus possible to modify the model of the user type (i.e. the avatar) (step 106) and then redefine the target user group (step 100) to adapt the campaign to the new selection, and so on.

In the case of an advertising campaign, the step of initial definition of the target users may be for example performed by the sales personnel who create their own avatars (which could be defined as “Avatars Model”), entering basic information about those customers whom they consider to be their target customers, for example on the basis of experience or initial market research.

After starting the system, the responses of the users will continue to modify the avatars. The “state of health” (or conversion level) of the avatars may also represent in real time the progression of the advertising campaign. The representation may also be illustrated for example by means of graphs or the like on a screen. The marketing department may thus easily make forecasts and decide on strategies based on available data which is always up-to-date and real.

The end user will receive a notification (i.e. message) via the mobile device and can decide for example whether to accept, reject, view or forward the offer as mentioned above. This information is recorded by the system (“Users Reactor Engine”) which will modify the user's profile (contained in the User Data Model) and will send the notification of variation in real time so that the avatar can modify the conversion level and adapt its own “cognitive model” to the answers received.

At this point it is clear how the objects of the invention have been achieved.

During operation of the system (for example during a product promotion) the avatar is continually prompted by the users' reactions and, by analysing the users' reactions (e.g. the four response possibilities mentioned above, i.e. rejection/disinterest, forwarding to another user, conversion/interest, archiving), the avatar has the possibility of varying the user clusters initially defined and identifying new patterns of interest by means of an automatic learning process which can be associated with or based on techniques typical of the world of data mining, i.e. clustering, neural networks, decision trees, association analysis, implemented in the comparator module 20, as may be now easily imagined by the person skilled in the art on the basis of the description of the invention provided here.

The analysis and variation of the “target” clusters, i.e. the group of users selected by the system, is continuous and adaptive, thanks to the techniques described above and the continuous prompting of user reactions via their devices 24.

At the start of a new message campaign, the system may also employ data previously characterizing a user type to suggest possible changes to the user type characteristics manually entered.

This may lead the computerized system to adapt more rapidly the characteristics of the initial user type to the characteristics of the ideal user type supplied by the responses of the real users.

Obviously the description given above of embodiments applying the innovative principles of the present invention is provided by way of example of these innovative principles and must therefore not be regarded as limiting the scope of the rights claimed herein.

For example, the structure of the system 10 has been described here as a set of separate elements, modules and databases. In its practical realisation it may however be realized using any system of the prior art. For example, the system 10 may advantageously be realized by means of one or more servers connected to the Internet network so as to convey the messages to the mobile terminals and receive the responses from the users. In this case, the method may be implemented by means of a suitable computer program installed on the server(s) of the system.

The sending of a response by the user may also be associated with a benefit provided to the user, so as to induce him/her to send the responses and thus supply more rapidly the system of refinement of the user type on the basis of the messages sent.

For example, each answer given by the user can be associated with points which increase a user's reward pool. These points can then, for example, be spent by the user on more advantageous campaign product offers.

Although for simplicity's sake the avatar or user type has been mainly described here as being only one, in reality the system may have several avatars or user types acting simultaneously to select different user groups or also to send each of their own messages to the same user or group of users, as can now be easily imagined by the person skilled in the art.

In order to make the messages more appealing, they may obviously take forms different forms from those of a simple text message. For example, pictures, animations, films, etc. may also be used. Virtual reality techniques may also be used, for example to ensure that the message is placed in a real context recorded by a camera integrated in the mobile device 24. For example, the user in a shopping centre could view messages in the form of gift boxes to be opened and placed inside or near shops in the shopping centre or near specific products on sale.

1. A computerized method for dynamic selection of groups of users to whom messages are to be sent, comprising in a computerized system a first definition phase comprising in turn the steps of:
forming a general database of users with information characterizing each user,
entering information characterizing an initial user type into a user type database;
entering one or more messages associated with the user type in a message database;
and a second operating phase in which the computerized system automatically:
selects a group of real users from the general database of users based on the characteristics defined for the user type;
sends to a personal device of the users of the selected real user group the messages of the message database associated with the user type;
receives from the personal device of the users an answer entered by the user in response to the message received;
extracts from the answers received from users a modification of the information characterizing the user type in the database of the user type; and
cyclically repeats the second operating phase for a dynamic selection of the user group to whom the messages of the message database associated with the user type are to be sent.

2. The computerized method according to claim 1, wherein the answer entered by the user is selected from a predefined set of answers.

3. The computerized method according to claim 2, wherein the predefined set of answers includes at least one message acceptance answer and one message rejection answer.

4. The computerized method according to claim 3, wherein the predefined set of answers also includes at least one answer for forwarding the message to others and an answer for archiving the message for future use.

5. The computerized method according to claim 2, wherein the personal devices are equipped with a touch screen and the user may enter an answer by means of a sliding movement on this touch screen.

6. The computerized method according to claim 1, wherein the information characterizing each user and the information characterizing the user type are chosen from among at least one or more of the following characteristics: age, geographical location, sex.

7. The computerized method according to claim 1, further comprising providing a database of correlations between products associated with the messages and modifying the information characterizing each user type also on the basis of the correlations between products contained in said correlation database.

8. A computerized information system implementing a dynamic selection of groups of users to whom messages are to be sent, comprising:
a user type database of information characterizing a user type;
a message database into which one or more messages associated with the user are entered;
a general user database of users with information characterizing each user;
a terminal suitable for entering messages in the message database and information characterizing at least one user type in the user type database of information characterizing the user type;
a comparator module for comparison of the information contained in the general user database and in the user type database of information characterizing the user type, and the selection of real user groups from the general user database depending on the result of the comparison;
a sending module suitable for sending messages contained in the message database to personal devices of the user groups selected by the comparator module; and
a module for receiving answers from the personal devices, able to modify on the basis of the answers received the information present in the database of information characterizing the user type.

9. The computerized information system according to claim 8, wherein the personal devices are smartphones.

10. The computerized information system according to claim 8, wherein the personal devices and the computerized system communicate via a wireless communication network and, preferably, a cellular communication network.

11. The computerized information system according to claim 8, wherein it comprises a further database for correlating products associated with the messages contained in the message database and adapted to modify, on the basis of such product correlations, the information contained in the database of information characterizing a user type.

12. The computerized information system according to claim 8, wherein:
an answer entered by one of the users in the user groups in response to the message received is received from the personal device of the one of the users; and
the answer entered by the one of the users is selected from a predefined set of answers.

13. The computerized information system according to claim 12, wherein the predefined set of answers includes at least one message acceptance answer and one message rejection answer.

14. The computerized information system according to claim 13, wherein the predefined set of answers also includes at least one answer for forwarding the message to others and an answer for archiving the message for future use.

15. The computerized information system according to claim 12, wherein the personal devices are equipped with a touch screen and the user may enter an answer by means of a sliding movement on this touch screen.

16. The computerized information system according to claim 8, wherein the information characterizing each user and the information characterizing the user type are chosen from among at least one or more of the following characteristics: age, geographical location, sex.

17. The computerized information system according to claim 8, further comprising providing a database of correlations between products associated with the messages and modifying the information characterizing each user type also on the basis of the correlations between products contained in said correlation database.
